(19) United States
(12) Patent Application Publication
(10) Pub. No.: US 2026/0264837 A1
(43) Pub. Date: Sep. 10, 2026

(54) AIRCRAFT WING ASSEMBLY

(71) Applicant: Airbus Operations Limited, FILTON, BRISTOL (GB)

(72) Inventor: Thomas BARNETT, FILTON, BRISTOL (GB)

(21) Appl. No.: 19/011,976

(22) Filed: Jan. 7, 2025

(30) Foreign Application Priority Data
Jan. 11, 2024 (GB) 2400414.5

(51) Int. Cl. B64C 3/20; B64C 3/18; B64F 5/10

(52) U.S. Cl. CPC B64C 3/20; B64C 3/182; B64C 3/187; B64F 5/10

(57) ABSTRACT

An aircraft wing assembly, comprising: a stringer, the stringer comprising a first flange, a second flange, and a web extending between, and connecting, the first flange and the second flange; a skin section; and a rib; wherein the first flange is joined to the skin section and the second flange is joined to the rib. Also a method of fabricating the aircraft wing assembly and an aircraft comprising the aircraft wing assembly.

### CROSS-REFERENCES TO RELATED APPLICATIONS

This application claims the benefit of Great Britain Patent Application Number 2400414.5 filed on Jan. 11, 2024, the entire disclosure of which is incorporated herein by way of reference.

### FIELD OF THE INVENTION

The present invention relates to aircraft wing assemblies, and to methods of fabricating aircraft wing assemblies.

### BACKGROUND OF THE INVENTION

Aircraft wing assemblies are structures which form the shape of the wings of an aircraft and provide mechanical robustness to the wings, such that the wings may withstand the high loads generated at the wings when the aircraft is in flight. Generally, an aircraft wing assembly comprises elongate stringers, which extend along a length of the wing, and ribs, which separate the wing into sections along the length. The aircraft wing assembly may also comprise spars that separate the sections widthwise, the spars extending parallel to the stringers. Such aircraft wing assemblies can also be referred to as wingboxes.

### SUMMARY OF THE INVENTION

A first aspect of the present invention provides an aircraft wing assembly, comprising: a stringer, the stringer comprising a first flange, a second flange, and a web extending between, and connecting, the first flange and the second flange; a skin section; and a rib; wherein the first flange is joined to the skin section and the second flange is joined to the rib.

In a conventional aircraft wing assembly, the rib, skin section and stringer are arranged such that the stringer passes through an opening, sometimes called a ‘mousehole’, through the rib and the rib is joined to the skin section directly. Use of mouseholes is only practical for a restricted range of shapes of stringers, such as ‘L’-shaped or ‘T’-shaped stringers, as they comprise only one flange.

In embodiments of the present invention, the rib is joined to the stringer at the second flange, which eliminates the need for such a mousehole. In this manner, a broader range of stringers, such as ‘J’-shaped, ‘C’-Shaped or ‘I’-shaped stringers, can be used. Such stringer shapes may have advantageous mechanical properties, compared to the conventionally used ‘T’-shaped or ‘L’-shaped stringers.

Fabricating a rib without mouseholes is also comparatively simpler, as no additional shaping or machining step is required to provide mouseholes.

The rib may not be joined directly to the skin section. Avoiding the need to join the rib to the skin section directly means that fasteners protruding through an outer surface of the skin section can be avoided. Such protruding fasteners can otherwise negatively impact aerodynamic flow over the outer surface of the skin section when the aircraft is in flight. Optionally, the rib is joined to the skin section only via the stringer.

Optionally, the first flange is joined directly to the skin section.

Optionally, the second flange is joined directly to the rib.

Optionally, the first flange is co-cured with the skin section. This avoids the need for mechanical fasteners, such as rivets or bolts, which protrude from an outer surface of the skin section, to join the first flange to the skin section. This reduces weight and allows an outer surface of the skin section to be smoother, thus improving aerodynamic flow over the outer surface of the skin section when the aircraft is in flight.

Optionally, the stringer is co-cured with the skin section. This can facilitate assembly of the aircraft wing assembly. The aircraft wing assembly can therefore be considered to include a unitary (or one-piece) structure, comprising the stringer and the skin section.

Optionally, the stringer is made of, or comprises, a carbon fiber composite material. This enables the stringer to be strong and lightweight.

Optionally, the first flange and the second flange have an equal width such that the stringer has an ‘I’-shaped cross section. The cross-sectional shape of the stringer dictates specific (per unit mass) mechanical properties, such as stiffness, of the stringer. Structural components with an ‘I’ cross section, having two equal flanges connected by a centered web, are known to have superior specific mechanical properties, compared to other possible cross-sectional shapes.

Optionally, the aircraft wing assembly comprises a plurality of the stringers. An example number of stringers is any number between five and twenty, such as eight or nineteen.

Optionally, the aircraft wing assembly comprises a plurality of the ribs attached to the plurality of the stringers. An example number of ribs is any number between fifteen and thirty-five, such as twenty or thirty-three.

Optionally, the aircraft wing assembly comprises a plurality of stringers, the skin section is a first skin section, and the aircraft wing assembly comprises a second skin section, such that at least one of the plurality of stringers is attached to the first skin section, and at least one of the plurality of the stringers is attached to the second skin section. The first skin section and the second skin section may be different regions of a wing skin, such as different regions of a unitary (or one-piece) wing skin.

The at least one of the plurality of stringers which is attached to the first skin section may be different from the at least one of the plurality of stringers attached to the second skin section. Optionally, there are several stringers of the plurality of stringers attached to each of the first skin section and the second skin section, respectively.

Optionally, the rib comprises a rib flange, and the second flange is joined to the rib flange.

Optionally, the second flange is joined to the side of the rib by a plurality of fasteners. The fasteners may optionally be selected from: bolts, rivets and screws.

A second aspect of the present invention provides a method of fabricating an aircraft wing assembly, the method comprising: providing a stringer, the stringer comprising a first flange, a second flange, and a web extending between, and connecting, the first flange and the second flange, and providing a skin section joined to the first flange; and joining a rib to the second flange. The skin section and the stringer may be discrete and connected to each other, or they may be a unitary structure (i.e., one piece).

The method of fabricating an aircraft structural assembly enables the advantages of the aircraft structural assembly according to the first aspect to be achieved.

Optionally, the providing the skin section joined to the first flange comprises co-curing the skin section with the first flange.

Optionally, the providing the skin section joined to the first flange comprises co-curing the skin section with the stringer.

Optionally, the providing the stringer comprises providing a stringer made of a carbon fibre composite material.

Optionally, the providing the stringer comprises providing the stringer such that the first flange and the second flange have an equal width such that the stringer has an ‘I’-shaped cross section.

Optionally, the providing the stringer comprises providing a plurality of the stringers.

Optionally, the joining the rib comprises joining a plurality of the ribs to the plurality of the stringers.

Optionally, the providing the stringer comprises providing a plurality of stringers, and the providing the skin section comprises providing a first skin section and a second skin section, such that at least one of the plurality of stringers is attached to the first skin section, and at least one of the plurality of the stringers is attached to the second skin section.

Optionally, the joining the rib to the second flange comprises joining a rib flange of the rib to the second flange.

Optionally, the joining the rib to the second flange comprises joining the rib to the second flange using a plurality of fasteners. The fasteners may optionally be selected from: bolts, rivets and screws.

A third aspect of the present invention provides an aircraft comprising the aircraft wing assembly of the first aspect.

Optional features of any one of the aspects of the present invention may be applied equally to any other one of the aspects of the present invention, where appropriate.

### BRIEF DESCRIPTION OF THE DRAWINGS

Embodiments of the invention will now be described, by way of example only, with reference to the accompanying drawings, in which:

FIG. 1 shows a schematic view of an aircraft according to an example embodiment of the present invention.

FIG. 2 shows an aircraft wing assembly of the aircraft of FIG. 1, according to an example embodiment of the present invention.

FIG. 3 shows a partial cross-sectional view of the aircraft wing assembly of FIG. 2.

FIGS. 4A and 4B show, respectively, a side view of a stringer of the aircraft wing assembly of FIG. 2, and a cross-sectional view of the same.

FIG. 5 shows a side view of a rib of the aircraft wing assembly of FIG. 2.

FIG. 6 shows an example method of fabricating the aircraft wing assembly of FIG. 2, according to an example embodiment of the present invention.

### DETAILED DESCRIPTION OF THE PREFERRED EMBODIMENTS

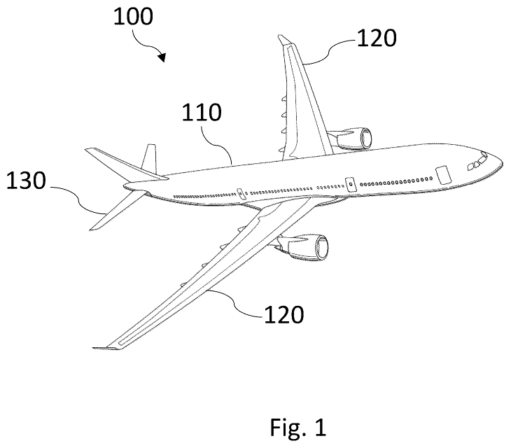

FIG. 1 shows an aircraft 100 according to an example of the invention. The aircraft comprises a fuselage 110, wings 120, and a tail 130. Each of the wings 120 comprises an aircraft wing assembly that embodies the present invention.

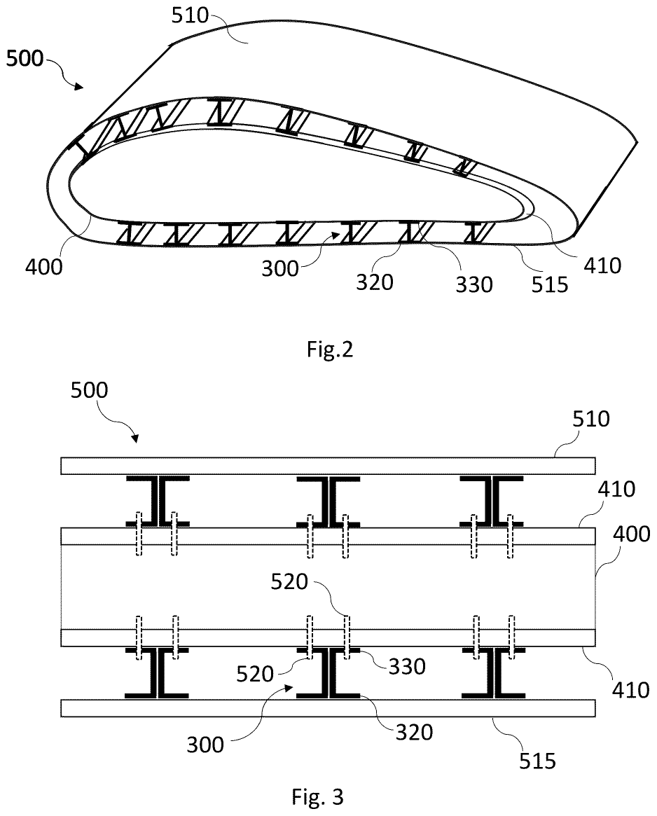

FIG. 2 shows a cross section through one of the wings 120, to show an example of one of the aircraft wing assemblies 500, and FIG. 3 shows a partial cross-sectional view of the aircraft wing assembly 500.

With reference to FIGS. 2 and 3, the wing assembly 500 comprises a skin composed of a first skin section 510, located at a first top side of the wing 120, and a second skin section 515, located at a second underside of the wing 120. The first skin section 510 and the second skin section 515 define a one-piece, continuous aerodynamic surface. In other embodiments, the first skin section and/or the second skin section may be formed of two or more joined skin sections, for example joined by welding or riveting.

The wing assembly 500 comprises a series of stringers 300 arranged side by side and aligned with each other. Each of the stringers 300 is attached to either the first skin section 510 or the second skin section 515. In this example, there are eight stringers 300 joined to the first skin section 510 and seven stringers joined to the second skin section 515. In other example embodiments of the wing assembly, a different number of stringers may be joined to each of the respective skin sections.

The stringers 300 are elongate components, arranged such that the stringers 300 have a longest dimension along (or in a direction of) a span of the wing 120. Each of the stringers 300 comprises a first flange 320 at which the respective first or second skin section 510, 515 is attached to the stringer 300. In this embodiment of the wing assembly 500, the stringers 300 are co-cured with the respective first or second skin section 510, 515. There are therefore no fasteners protruding through the first skin section 510 or the second skin section 515. In other example embodiments of the wing assembly, the stringers may be joined to the respective skin sections in another manner, for example using mechanical fasteners, such as bolts or rivets, welding or an adhesive.

The stringers 300, the first skin section 510 and second skin section 515 are all formed from a carbon fiber composite material, in this example. Both the first and second skin sections 510, 515 and the first flange 320 of the stringers 300 comprise a curable material in order for the co-curing to form a joint therebetween. In other example embodiments of the wing assembly, for example where co-curing is not used, the skin sections and the stringers may be made of dissimilar materials and/or may be made of materials that are not curable.

Each of the stringers 300 further comprises a second flange 330, which is attached to a flange 410 of a rib 400. The rib 400 is arranged such that the rib 400 is in a plane of the cross-section as shown in FIG. 2. In the view of FIG. 3, the stringers 300, the first skin section 510 and second skin section 515 extend in a direction into the page and the rib 400 lies in the plane of the page.

The wing assembly 500 comprises a plurality of ribs 400 spaced apart in a direction along the span of the wing 120 and along a length of the stringers 300. Different embodiments of the wing 120 may comprise a different number of ribs 400. The presently described wing 120 comprises twenty ribs 400, of varying size to produce a chordwise tapered shape, as is shown in FIG. 1. Some of the stringers 300 do not reach all of the ribs 400 of the wing 120. In particular, in the direction of the span of the wing 120 from the fuselage 110, some of the stringers 300 terminate before reaching some of the ribs 400 towards a tip end of the wing 120.

In FIG. 3, it is shown that the second flange 330 of each respective stringer 300 is attached to the flange 410 of the rib 400 by a pair of bolts 520, in this example embodiment. In other embodiments, there may be fewer or more of the bolts 520 or an alternative method of attachment may be used, for example an alternative mechanical fastener type.

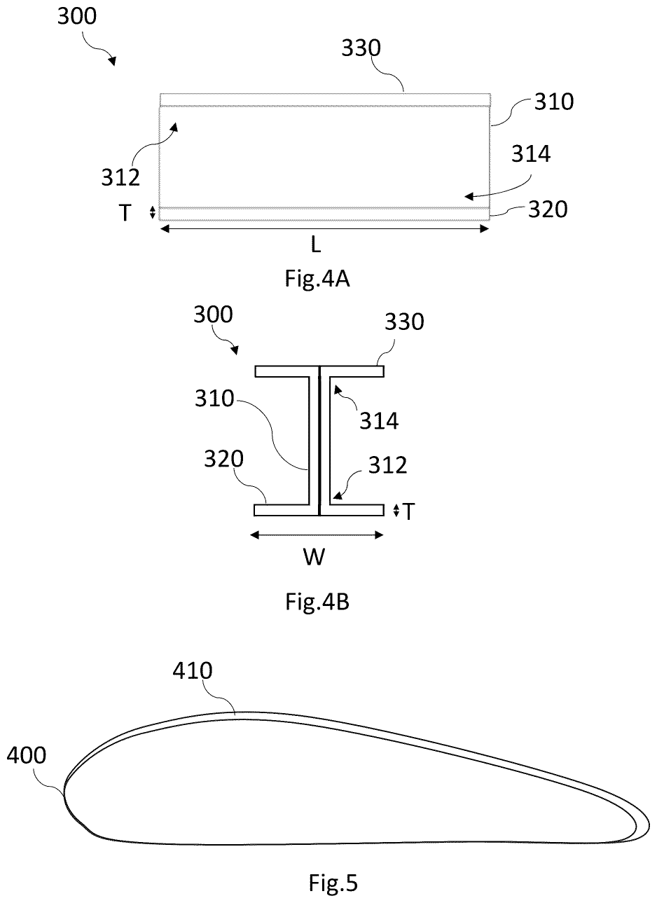

FIGS. 4A and 4B show one of the stringers 300 in more detail. The stringer 300 comprises the first flange 320 and the second flange 330, which are connected by a web 310. The first flange 320 is at a first end 312 of the web 310 and the second flange 330 is at a second end 314 of the web 310. In this example, the first flange 320 and the second flange 330 each have the same width W and thickness T. The stringer 300 also has a length L.

In this example embodiment, the stringer 300 is of a ‘I’-shaped cross-section, formed by two ‘C’-shaped halves that are arranged with the mid-portions of the ‘C’s back-to-back. The mid-portions of the two ‘C’-shaped halves are co-cured so that the stringer 300 is a unitary structure. In other examples, the stringer may be any stringer which has two flanges connected by a web, such as for example a standalone ‘C’-shaped stringer, a ‘J’-shaped stringer, or may have dissimilar width W and/or thickness T at the first and second flange, for example.

The rib 400 is shown in FIG. 5, which shows that the flange 410 of the rib 400 wraps around a full perimeter of the rib 400. In other embodiments, the flange may be absent or of a different form, such as discontinuous around the perimeter of the rib. The rib is in this example also formed of a carbon fiber composite material, but may comprise different materials in other embodiments, such as another composite material or a metallic material.

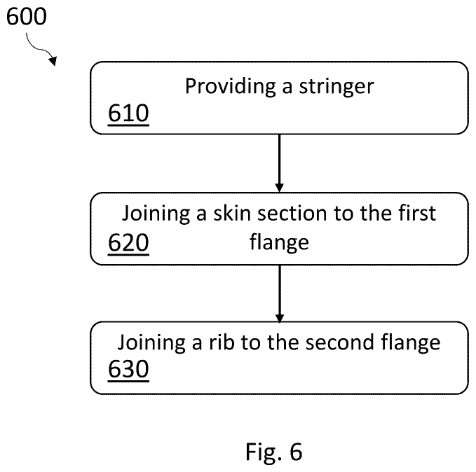

An example method 600 of fabricating a wing assembly according to an example of the present invention is shown in FIG. 6. The method 600 is a method of fabricating the wing assembly 500, in this example.

The method 600 comprises providing 610 a stringer. In this example, the providing 610 the stringer comprises providing the plural stringers 300. In other example methods, the providing 610 the stringer may comprise providing a different stringer according to another embodiment of the present invention, as discussed above.

The method 600 comprises joining 620 a skin section to a first flange of the stringer. In this example, the joining 620 the skin section to the first flange of the stringer comprises co-curing the first flange 320 of the stringer 300 with the first or the second skin section 510, 515. In other example methods, the joining 620 the skin section to the first flange of the stringer may comprise joining a different first flange of a stringer according to another embodiment of the present invention, as discussed above, to a skin section, and/or may not comprise co-curing.

The method 600 also comprises joining 630 a rib to a second flange of the stringer. In this example, the joining 630 the rib to the second flange of the stringer comprises joining the second flange 330 of the stringer 300 to the flange 410 of the rib 400 using the bolts 520. In other example methods, the joining 630 the rib to the second flange of the stringer may comprise joining a different second flange of a stringer to a rib. The joining 630 may alternatively comprise use of other joining methods, such as other mechanical fastener types.

It is to be noted that the term “or” as used herein is to be interpreted to mean “and/or”, unless expressly stated otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft wing assembly, comprising:
a stringer, the stringer comprising a first flange, a second flange, and a web extending between, and connecting, the first flange and the second flange;
a skin section; and
a rib;
wherein the first flange is joined to the skin section and the second flange is joined to the rib.

2. The aircraft wing assembly of claim 1, wherein the first flange is co-cured with the skin section.

3. The aircraft wing assembly of claim 2, wherein the stringer is co-cured with the skin section.

4. The aircraft wing assembly of claim 1, wherein the stringer is made of a carbon fiber composite material.

5. The aircraft wing assembly of claim 1, wherein the first flange and the second flange have an equal width such that the stringer has an ‘I’-shaped cross section.

6. The aircraft wing assembly of claim 1, further comprising:
a plurality of stringers, wherein the skin section is a first skin section, and
a second skin section, such that at least one of the stingers from the plurality of stringers is attached to the first skin section, and at least one of the stingers from the plurality of the stringers is attached to the second skin section.

7. The aircraft wing assembly of claim 1, wherein the rib comprises a rib flange, and the second flange is joined to the rib flange.

8. The aircraft wing assembly of claim 1, wherein the second flange is joined to the rib by a plurality of fasteners.

9. A method of fabricating an aircraft wing assembly, the method comprising:
providing a stringer, the stringer comprising a first flange, a second flange, and a web extending between, and connecting, the first flange and the second flange, and providing a skin section joined to the first flange; and
joining a rib to the second flange.

10. The method of claim 9, wherein the providing the skin section joined to the first flange comprises co-curing the skin section with the first flange.

11. The method of claim 10, wherein the providing the skin section joined to the first flange comprises co-curing the skin section with the stringer.

12. The method of claim 9, wherein the providing the stringer comprises providing a stringer made of a carbon fiber composite material.

13. The method of claim 9, wherein the providing the stringer comprises providing the stringer such that the first flange and the second flange have an equal width such that the stringer has an ‘I’-shaped cross section.

14. The method of claim 9, wherein the providing the stringer comprises providing a plurality of stringers; and
wherein the providing the skin section comprises providing a first skin section and a second skin section, such that at least one of the stringers from the plurality of stringers is attached to the first skin section, and at least one of the stringers from the plurality of the stringers is attached to the second skin section.

15. The method of claim 9, wherein the joining the rib to the second flange comprises joining a rib flange of the rib to the second flange.

16. The method of claim 9, wherein the joining the rib to the second flange comprises joining the rib to the second flange using a plurality of fasteners.

17. An aircraft comprising:
the aircraft wing assembly of claim 1.
